(19) United States
(12) Patent Application Publication
(10) Pub. No.: US 2025/0319781 A1
(43) Pub. Date: Oct. 16, 2025

(54) Charging Port Device

(71) Applicant: Mercedes-Benz Group AG, Stuttgart (DE)

(72) Inventors: Claudia SEIDLER, Boeblingen (DE); Holger ENZMANN, Altdorf (DE)

(21) Appl. No.: 18/866,282

(22) PCT Filed: May 15, 2023
(86) PCT No.: PCT/EP2023/063027

§ 371 Date: Nov. 15, 2024

(30) Foreign Application Priority Data
May 16, 2022 (DE) 10 2022 001 702.4

(51) Int. Cl. B60L 53/16; H01R 13/453; H01R 13/52

(52) U.S. Cl. CPC B60L 53/16; H01R 13/4532; H01R 13/4534; H01R 13/5213; H01R 2201/26

(57) ABSTRACT

A charging port device for an electrically driven vehicle includes a charging inlet with a first charging port and a second charging port and a charging inlet cover which has an open position and a closed position. In the charging inlet, a cover element is disposed within the charging inlet cover which alternately covers the first charging port and the second charging port. The cover element has an adjustable width which is settable according to a respective width of the first charging port and the second charging port.

### BACKGROUND AND SUMMARY OF THE INVENTION

The invention relates to a charging port device for an electrically driven vehicle, having a charging inlet with at least two charging ports for charging plugs.

According to the prior art, for each charging standard, electric cars need a separate charging port and therefore two charging ports are provided on the vehicle for two charging options conforming to different standards.

A charging standard can include direct current charging, which is understood to mean charging with direct current, or alternating current charging, which is understood to mean charging with alternating current. Charging ports can have different plug standards.

One charging standard currently used in Europe is, for example, the so-called combined charging system (CCS). Here, charging with direct current and alternating current is possible. A further standard CHAdeMO=“Charge de Move” as a standard developed in Japan, provides a charging power up to 50 kW. For the prospective mega-watt charging with powers of at least one megawatt, a further charging port is provided according to a further plug standard. Multiple charging ports can be electrically connected in a path so that the charging sockets are simultaneously powered.

If, for example, two charging ports are arranged in a charging inlet, when a charging plug is inserted into a charging port, the respective other charging port that is not being used must be covered, in particular so as to be safe to touch and/or protected against environmental influences. In this regard, there are also sometimes statutory standards, in particular country-specific statutory standards, which require this. That is not possible in the typically provided installation space with a displaceable cover, with consideration of the standard gripping spaces. Currently, therefore charging ports are covered by stoppers or cover flaps. Stoppers prove to be unwieldly, whereas cover flaps require more installation space.

The generic document DE 10 2021 000 307 A1 shows a charging port device for an electrically driven vehicle with two charging ports arranged next to each other, for example two charging sockets for a first direct current charging port and a second direct current and/or alternating current charging port. At least one charging port cover covers at least one of the two charging ports and the charging port cover is designed so that in each case only one of the two charging ports is accessible for contact, while the other of the two charging ports is covered by the charging port cover.

DE 10 2018 124 996 A1 discloses a media filling system, in particular a charging flap system or tank filling system for a motor vehicle. The media filling system comprises a bowl, in which at least one media connection area for a media coupling point and a hinge box are provided, and a flap that can be swivelled via a hinge arm. The hinge arm is at least partially received in a receiving space of the hinge box. At least when the flap is in the open position, the media connection area is connected to the receiving space via a through opening. Furthermore, a shutter assigned to the hinge box is provided, which closes the through opening at least in sections when the flap is in the open position.

DE 10 2019 000 462 A1 discloses a charging port device for a vehicle, comprising a connection socket arranged in a recess and a pivotably arranged connection socket cover flap and a pivotably arranged cover flap. The connection socket cover flap and the cover flap can each be pivoted into an open position and into a closed position, wherein the connection socket cover flap covers the connection socket in the closed position. The cover flap covers the recess. If the cover flap and the connection socket cover flap are displaced from the respective open position into the respective closed position, the cover flap brings the connection socket cover flap with it when it is being closed. In the closed position of the connection socket cover flap, the connection socket cover flap is magnetically releasably held by the connection socket connecting device.

An object of the invention is to create an improved charging port device for an electrically driven vehicle having two charging ports.

According to one aspect of the invention, a charging port device for an electrically driven vehicle is provided, having a charging inlet with at least two charging ports for charging plugs and having a charging inlet cover to cover the charging inlet, which has an open position and a closed position. In the charging inlet, a cover element is arranged within the charging inlet cover which selectively covers one of the two charging ports, in particular so as to be safe to touch and/or protected against environmental influences. In this regard, there are also sometimes statutory standards, in particular country-specific statutory standards, which require this.

In this case, the cover element is designed according to the invention with an adjustable width which can be set according to the respective widths of the at least two charging ports.

In this case, the cover element is arranged inside the charging inlet cover when the charging inlet cover is in the closed state, specifically between the charging ports and the charging inlet cover.

With the provided charging port device, two charging ports can be arranged in a charging inlet having a charging inlet cover, however only one charging port can be accessed safely at any one time. Here, a second internal moveable cover element is arranged in the charging inlet, which can be slid, pivoted or folded back and forth between the two charging ports. So that each of the charging ports can be completely covered with the one cover element even if the two charging ports have different widths, the cover element is designed to be adjustable in width. This can be achieved, for example, by a simple sliding link.

For this purpose, the charging port device has a cover element which can be set to a variable width. The width of the cover element can be adapted individually to the respective charging port in use. A cover element can be used to securely cover alternating charging ports of different widths. The cover element can comprise two or more cover element parts of different widths, which can be displaced in a simple manner into the respective position, for example via a sliding guide and abutments, and can cover the respective charging port.

Advantageously, such a cover element enables easy handling of the charging port device when changing the charging port to be plugged in. This minimizes the installation space requirement for the cover element which can be integrated in an advantageous manner into a charging inlet. Manual intervention is no longer necessary before closing the charging inlet cover to close the vehicle outer skin. Advantageously, an automatic charging inlet cover can be closed at any time after withdrawing the charging plug.

According to an advantageous embodiment of the charging port device, the cover element can be moved from one charging port to the other of the at least two charging ports by at least one of the following: sliding, folding, pivoting. In this manner, the cover element can alternately cover one of the charging ports or another of the charging ports quickly and flexibly, so that when the charging plug is inserted, the respective other charging port is covered securely, in particular so that it is safe to touch and protected from environmental influences.

According to an advantageous embodiment of the charging port device, the cover element can have at least one first cover element part and at least one second cover element part, which are connected via a sliding link so that they can be displaced relative to each other. Advantageously, the width of the cover element can be easily adapted to the width of the charging port to be covered. This can be achieved simply by making the cover element with sliding link in two or more parts, whereby the two end states (narrow and wide, or wide and narrow) can be defined and the inner cover element can therefore be designed simply and flexibly.

According to an advantageous embodiment of the charging port device, the cover element can be moved from one charging port to the other of the at least two charging ports via a guide device. The cover element can also have a mechanism as a guide device, which makes it easier to adapt to the width of the charging port or adapts automatically when sliding or folding or pivoting or can move in a self-regulating manner and thus adapts when plugged or pushed into the charging port.

According to an advantageous embodiment of the charging port device, the movement of the at least one first cover element part and of the at least one second cover element part in the guide device can cause the at least one first cover element part and the at least one second cover element part to be displaced relative to each other via the sliding link. In particular, the sliding link can be integrated in the guide device. Particularly when the cover element is slid, an external guide rail can cause an internal displacement of the two cover element parts. To this end, the sliding link can then optionally also be a part of the guide device in the guide rail.

According to an advantageous embodiment of the charging port device, the cover element can have at least one lock and/or sliding aid and/or insertion aid for arranging the cover element on the at least two charging ports. In particular, the at least one lock and/or sliding aid and/or insertion aid can be integrated in the guide device, in particular as a locking lug or locking indentation. Advantageously, such a cover element can have locks and/or sliding aids and/or insertion aids which facilitate and support the sliding or plugging when folding or pivoting onto the charging port and then also hold the cover element on the charging port. The cover element should then no longer be able to detach by itself without external intervention. In the case of sliding, this can simply be a small locking lug or locking indentation in the guide rail, which must be overcome in order to move.

According to an advantageous embodiment of the charging port device, the cover element can be releasably connected to the at least two charging ports via a detent mechanism. In particular, the cover element can be releasably connected to each of the at least two charging ports via a separate detent mechanism. When pivoting or folding the cover element, it must of course be possible to open this locking again so that it can fulfil its function and allow it to be folded back after the charging process. A simple latching bolt, for example, can be sufficient here to enable locking on both charging ports. Alternatively, each charging port can have its own latching bolt on each side or a lock for the respective charging port, as each charging port faces a different side of the surface of the cover element due to the folding process.

According to an advantageous embodiment of the charging port device, a blocking device can be provided, by means of which, when a charging plug is inserted into one of the at least two charging ports for charging, the cover element is locked on the other of the at least two charging ports. The cover element can optionally be blocked again by a blocking device during the charging process when an electrical voltage is applied to the charging ports, so that it cannot be released via the lock during charging and contact protection is thus ensured.

According to an advantageous embodiment of the charging port device, the cover element can have a circumferential edge which extends in the direction of the at least two charging ports and encompasses the respective covered charging port. In particular, in this case the at least one first cover element part and the at least one second cover element part have at least partially circumferential edges which extend in the direction of the at least two charging ports and work together to encompass the respective covered charging port.

The cover element can have an encompassing edge which extends at least in part in the direction of the charging port, in order to cover this better and optionally reinforce the edge at the same time. When sliding the cover element, the same side is always directed towards the charging port, so that an edge on the cover element that only extends in one direction is sufficient here, whereas when folding or pivoting, in which case the front and rear of the cover element face the charging ports, such an edge can protrude advantageously on both sides of the cover element. It must then still be possible to displace the cover element internally to set its width, so that the edge can be recessed in accordance with the cover element's sliding link or inserted into a corresponding recess.

According to an advantageous embodiment of the charging port device, the cover element can have a circumferential seal which extends in the direction of the at least two charging ports and seals the respective covered charging port against an environment. In particular, the at least one first cover element part and the at least one second cover element part can have at least partially circumferential seals which extend in the direction of the at least two charging ports and work together to seal the respective covered charging port against the environment.

Expediently, the cover element can also have a seal, despite the displacement options, which then not only covers the charging port, but also at least partially seals it. This seal must then allow the width of the cover element to be set according to the width adjustment options, so that the seal can also be correspondingly displaced and still fulfil its function. The seal can also be arranged on the charging port and then function as a seal together with the cover element when covered.

Further advantages result from the following description of the drawings. In the drawings, an exemplary embodiment of the invention is represented. The drawings, the description and the claims include numerous features in combination. The skilled person will also expediently consider the features individually and also combine the individual features of the exemplary embodiment of the invention in other ways within the scope of the claims.

### BRIEF DESCRIPTION OF THE DRAWINGS

FIG. 1 is a plan view of a charging port device for an electrically driven vehicle according to an exemplary embodiment of the invention with an open charging inlet cover and a first charging port, covered by a cover element;

FIG. 2 is a plan view of the charging port device according to FIG. 1, with a second charging port, covered by the cover element;

FIG. 3 is an isometric view of the charging port device according to FIG. 1 with open charging ports;

FIG. 4 is a detailed view according to FIG. 3 of a guide device for displacing the cover element;

FIG. 5 is a plan view of a front side of the cover element in a narrow state;

FIG. 6 is a plan view of a rear side of the cover element in a narrow state;

FIG. 7 is a plan view of the front side of the cover element in a wide state;

FIG. 8 is a plan view of the rear side of the cover element in a wide state;

FIG. 9 is a plan view of the front sides of the first cover element part and of the second cover element part; and

FIG. 10 is a plan view of the rear sides of the first cover element part and of the second cover element part.

### DETAILED DESCRIPTION OF THE DRAWINGS

In the figures, identical or similar components are provided with the same reference numerals. The figures only show examples and are not intended to be restrictive.

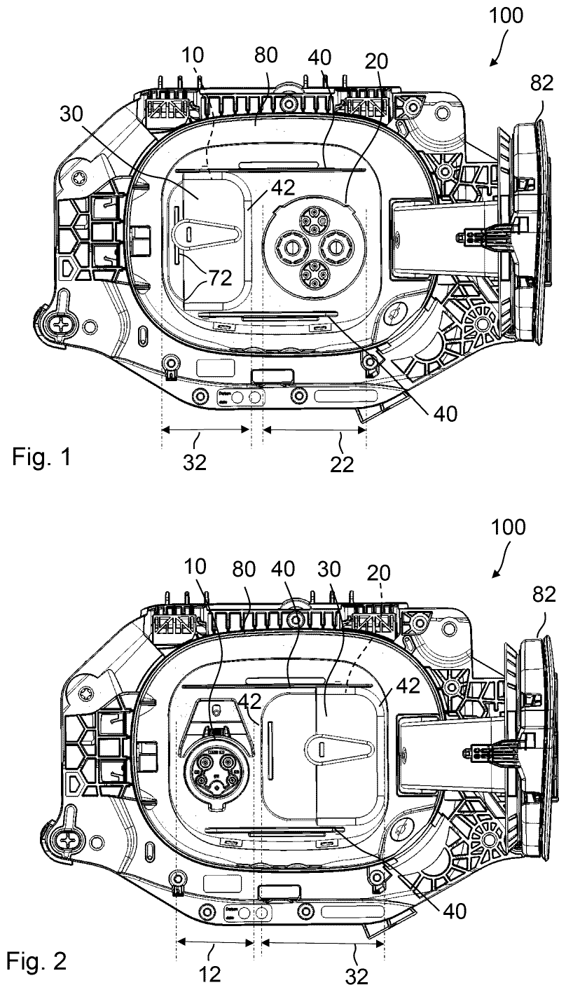

FIG. 1 shows a plan view of a charging port device 100 for an electrically driven vehicle according to an exemplary embodiment of the invention with an open charging inlet cover 82 and a first charging port 10, covered by a cover element 30;

The charging port device 100 comprises a charging inlet 80 with at least two charging ports 10, 20 for charging plugs and having a charging inlet cover 82 to cover the charging inlet 80, which has an open position and a closed position. The charging inlet cover 82 is shown in the open state in the representation in FIG. 1.

In the charging inlet 80, a cover element 30 is arranged within the charging inlet cover 82 (within meaning in the closed state of the charging inlet cover 82), which alternately covers one of the at least two charging ports 10, 20, in particular so as to be safe to touch and/or protected against environmental influences. The cover element 30 is designed with an adjustable width 32 which can be set according to the respective widths 12, 22 of the at least two charging ports 10, 20.

In different embodiments, the cover element 30 can be moved from one charging port 10, 20 to the other of the at least two charging ports 20, 10 by sliding or folding or pivoting. In the exemplary embodiment shown in FIG. 1, the cover element 30 covers the first charging port 10 and can be displaced as needed to the second charging port 20. For this purpose, the cover element 30 can be moved from one charging port 10, 20 to the other of the at least two charging ports 20, 10 via a guide device 40.

FIG. 2 shows the charging port device 100 with a second charging port 20, covered by the cover element 30.

In FIG. 1, the cover element 30 has a width 32 which corresponds to the width 12 of the first charging port 10, whereas in FIG. 2, the width 32 of the cover element 30 corresponds to the width 22 of the second charging port.

Advantageously, the cover element 30 can have at least one lock and/or sliding aid and/or insertion aid (not shown) for arranging the cover element 30 on the at least two charging ports 10, 20. In particular, the at least one lock and/or sliding aid and/or insertion aid can be integrated in the guide device 40, in particular as a locking lug or locking indentation.

Furthermore, the cover element 30 can be releasably connected to the at least two charging ports 10, 20 via a detent mechanism (not shown). In particular, the cover element 30 can be releasably connected to each of the at least two charging ports 10, 20 via a separate detent mechanism.

Expediently, a blocking device (not shown) can be provided, by means of which, when a charging plug is inserted into one of the at least two charging ports 10, 20 for charging, the cover element 30 is locked on the other of the at least two charging ports 10, 20.

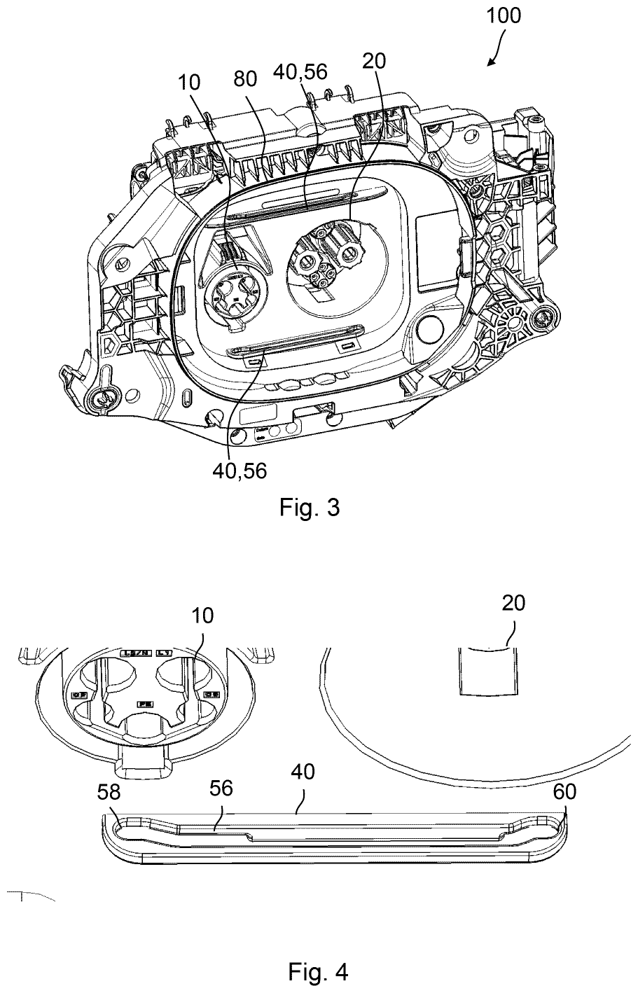

In FIG. 3, an isometric view of the charging port device 100 according to FIG. 1 with open charging ports 10, 20 is represented. The first charging port 10 is represented by way of example as a so-called type 1 charging port, whereas the second charging port 20 is represented as a charging port according to the CHAdeMO standard. It is understood that charging sockets can also be arranged in the charging inlet 80 according to other standards. Furthermore, slotted guides 56 of the guide device 40 for displacing the cover element 30 can be seen both above and below the charging ports.

In FIG. 4, a detailed view according to FIG. 3 of a guide device 40 for displacing the cover element 30 is represented. The slotted guide 56 of the guide device 40 has, for example, a first abutment 58 and a second abutment 60 for the cover element 30, which define a left and right abutment 58, 60 in the charging inlet 80.

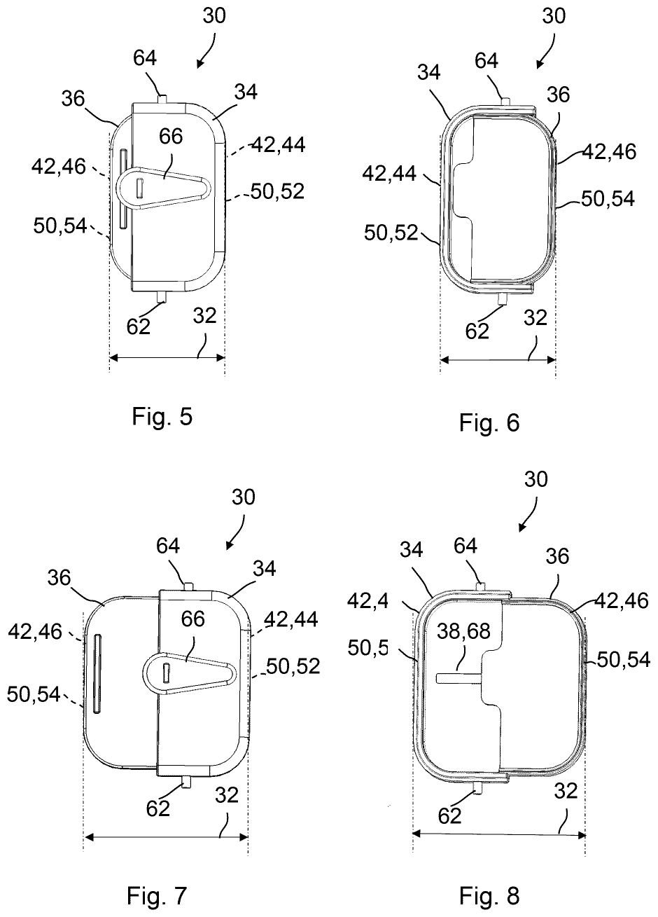

FIGS. 5 and 6 each show a plan view of a front side (FIG. 5) and a rear side (FIG. 6) of the cover element 30 in a narrow state with a width 32 which corresponds to the width of the first charging port 10, whereas FIGS. 7 and 8 each show a plan view of the front side (FIG. 7) and the rear side (FIG. 8) of the cover element 30 in a wide state with a width 32 which corresponds to the width of the second charging port 20.

To set the width 32 of the cover element 30, the cover element 30 has a first cover element part 34 and a second cover element part 36 which are connected via a sliding link 38 (seen in FIG. 8) so that they can be displaced relative each other.

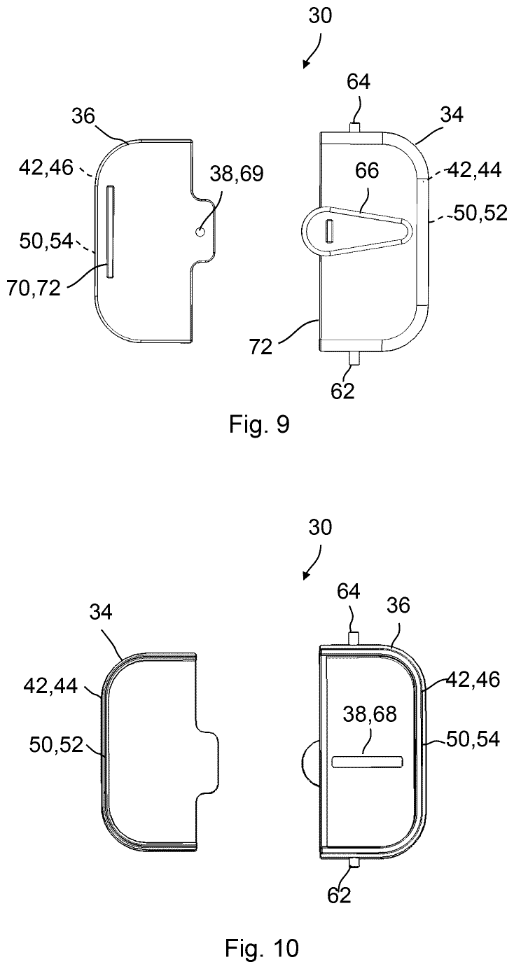

In FIG. 9, a plan view of the front sides of the first cover element part 34 and of the second cover element part 36 is represented, whereas in FIG. 10, a plan view of the rear sides of the first cover element part 34 and of the second cover element part 36 is represented.

The second cover element part 36 engages with a guide element 69 into the slotted guide 68 of the sliding link 38 of the first cover element part 34 and is connected in this manner to the first cover element part 34. Therefore, the width 32 of the cover element 30 can be set and changed by displacing the two cover element parts 34, 36 relative to each other.

The first cover element part 34 has two guide elements 62, 64 lying opposite each other, which engage into the slotted guide 56 of the guide device 40 of the charging inlet 80 and via which the cover element 30 can be displaced in the guide device 40.

To displace the cover element 30 in the guide device 40, the front side of the first cover element part 34 has a grip element 66, with which the cover element 30 can be displaced from one charging port 10, 20 to the other charging port 20, 10.

In an advantageous embodiment, the guide device 40 can be designed so that the movement of the first cover element part 34 and of the second cover element part 36 in the guide device 40 causes the first cover element part 34 and the second cover element part 36 to be displaced relative to each other via the sliding link 38. Thus, when displacing the cover element 30 in the guide device 40 from one charging port 10, 20 to the other charging port 20, 10, the correct width 32 of the cover element 30 can advantageously be set, which corresponds to the width 12, 22 of the charging port 10, 20 to be covered.

In an alternative embodiment, in particular the sliding link 38 can be integrated in the guide device 40.

Furthermore, in FIG. 9 also shows an elevation 70 on the front side of the second cover element part 36, which can serve as a tool mounting surface 72 and/or grip bar if the mobility of the second cover element part 36 is reduced or even completely prevented by external circumstances, such as dirt, adhesions or ice formation. Similarly, a side surface or side region of the first cover element part 34 can also serve wholly or at least partially as a tool mounting surface 72 should the mobility thereof alone or together with the second cover element part 36 be reduced or even completely prevented. The tool mounting surface 72 can be designed as a structurally reinforced area in order to be able to absorb the tool forces which are exerted here without damaging the first cover element part 34 and/or the second cover element part 36. Additionally, the tool mounting surface 72 can also have a suitable surface size in order to be able to attach the tool well and securely and to absorb the forces therefrom. Optionally, the tool mounting surface 72 or the area surrounding it also has a logo, icon or pictogram which indicates the function or the intended use purpose.

As can be seen in FIGS. 5 to 10, the cover element 30 can have a circumferential edge 42 which extends in the direction of the charging ports 10, 20 and encompasses the respective covered charging port 10, 20. In particular, the first cover element part 34 and the second cover element part 36 can have at least partially circumferential edges 44, 46 which extend in the direction of the charging ports 10, 20 and work together to encompass the respective covered charging port 10, 20.

Furthermore, the cover element 30 can have a circumferential seal 50 which extends in the direction of the charging ports 10, 20 and seals the respective covered charging port 10, 20 against an environment. In particular, the first cover element part 34 and the second cover element part 36 can have at least partially circumferential seals 52, 54 which extend in the direction of the charging ports 10, 20 and work together to seal the respective covered charging port 10, 20 against the environment.

Advantageously, the seals 50, 52, 54 can be integrated into the edges 42, 44, 46 of the cover element 30.

### LIST OF REFERENCE CHARACTERS

10 charging port
12 width
20 charging port
22 width
30 cover element
32 width
34 cover element part
36 cover element part
38 sliding link
40 guide device
42 edge
44 edge
46 edge
50 seal
52 seal
54 seal
56 slotted guide
58 first abutment
60 second abutment
62 guide element
64 guide element
66 grip element
68 slotted guide
69 guide element
70 elevation
72 tool mounting surface
80 charging inlet
82 charging inlet cover
100 charging port device

1.-13. (canceled)

14. A charging port device (100) for an electrically driven vehicle, comprising:
a charging inlet (80) with a first charging port (10) and a second charging port (20); and
a charging inlet cover (82) which has an open position and a closed position;
wherein in the charging inlet (80), a cover element (30) is disposed within the charging inlet cover (82) which alternately covers the first charging port (10) and the second charging port (20);
wherein the cover element (30) has an adjustable width (32) which is settable according to a respective width (12, 22) of the first charging port (10) and the second charging port (20).

15. The charging port device (100) according to claim 14, wherein the cover element (30) is movable from the first charging port (10) to the second charging port (20) and from the second charging port (20) to the first charging port (100) by sliding or folding or pivoting.

16. The charging port device (100) according to claim 14, wherein the cover element (30) has a first cover element part (34) and a second cover element part (36) which are connected via a sliding link (38) such that the first cover element part (34) and the second cover element part (36) are displaceable relative to each other.

17. The charging port device (100) according to claim 14, wherein the cover element (30) is movable from the first charging port (10) to the second charging port (20) via a guide device (40).

18. The charging port device (100) according to claim 17:
wherein the cover element (30) has a first cover element part (34) and a second cover element part (36) which are connected via a sliding link (38) such that the first cover element part (34) and the second cover element part (36) are displaceable relative to each other;
wherein a movement of the first cover element part (34) and the second cover element part (36) in the guide device (40) causes the first cover element part (34) and the second cover element part (36) to be displaced relative to each other via the sliding link (38) which is integrated in the guide device (40).

19. The charging port device (100) according to claim 14, wherein the cover element (30) has a lock or a sliding aid or an insertion aid for arranging the cover element (30) on the first charging port (10) and the second charging port (20).

20. The charging port device (100) according to claim 19:
wherein the cover element (30) is movable from the first charging port (10) to the second charging port (20) via a guide device (40);
wherein the lock or the sliding aid or the insertion aid is integrated in the guide device (40).

21. The charging port device (100) according to claim 14, wherein the cover element (30) is releasably connected to the first charging port (10) and the second charging port (20) via a detent mechanism.

22. The charging port device (100) according to claim 14, further comprising a blocking device via which, when a charging plug is inserted into one of the first charging port (10) and the second charging port (20) for charging, the cover element (30) is locked on the other of the first charging port (10) and the second charging port (20).

23. The charging port device (100) according to claim 14, wherein the cover element (30) has a circumferential edge (42) which extends in a direction of the first charging port (10) and the second charging port (20) and encompasses a covered one of the first charging port (10) and the second charging port (20).

24. The charging port device (100) according to claim 23:
wherein the cover element (30) has a first cover element part (34) and a second cover element part (36) which are connected via a sliding link (38) such that the first cover element part (34) and the second cover element part (36) are displaceable relative to each other;
wherein the first cover element part (34) and the second cover element part (36) have at least partially respective circumferential edges (44, 46) which extend in the direction of the first charging port (10) and the second charging port (20) and work together to encompass the covered one of the first charging port (10) and the second charging port (20).

25. The charging port device (100) according to claim 14, wherein the cover element (30) has a circumferential seal (50) which extends in a direction of the first charging port (10) and the second charging port (20) and seals a covered one of the first charging port (10) and the second charging port (20) against an environment.

26. The charging port device (100) according to claim 25:
wherein the cover element (30) has a first cover element part (34) and a second cover element part (36) which are connected via a sliding link (38) such that the first cover element part (34) and the second cover element part (36) are displaceable relative to each other
wherein the first cover element part (34) and the second cover element part (36) have at least partially respective circumferential seals (52, 54) which extend in the direction of the first charging port (10) and the second charging port (20) and work together to seal the covered one of the first charging port (10) and the second charging port (20) against the environment.
